(19) United States
(12) Patent Application Publication
(10) Pub. No.: US 2024/0362433 A1
(43) Pub. Date: Oct. 31, 2024

(54) ASSET TRACKING WITH RADIO-FREQUENCY IDENTIFICATION TAGS

(71) Applicant: Stage Lighting Patents, LLC, Windermere, FL (US)

(72) Inventors: Oliver Giles Hutchinson, Huddersfield (GB); Huntly Gordon Christie, Windermere, FL (US)

(73) Assignee: Stage Lighting Patents, LLC, Windermere, FL (US)

(21) Appl. No.: 18/308,208

(22) Filed: Apr. 27, 2023

(51) Int. Cl. G06K 7/10

(52) U.S. Cl. CPC G06K 7/10198; G06K 7/10356

(57) ABSTRACT

An example of an apparatus to track assets is provided. The apparatus includes a reader interface to connect to a radio-frequency identification reader. The apparatus further includes a first antenna interface to connect to a first antenna. In addition, the apparatus includes a second antenna interface to connect to a second antenna. Furthermore, the apparatus includes a switch to connect the first antenna interface to the reader interface in a first state and to connect the second antenna interface to the reader interface in a second state. The radio-frequency identification reader is to transmit a signal via the first antenna and to receive a first response from a tag via the first antenna in the first state. The radio-frequency identification reader is also to transmit and receive the signal via the second antenna in the second state. The apparatus also includes a switch controller to operate the switch automatically.

### BACKGROUND

Assets, such as equipment or inventory, are typically stored at a location capable of housing the assets. There are many reasons that a large number of assets may be stored. Management of the assets to track and locate assets when they are needed may be complicated and difficult, especially if the assets can be moved and repositioned within a large storage site. For example, a business may own assets that are to be loaned, rented, or leased out for use. The types of assets that may be handled in this manner is not limited and may include a wide variety of assets, such as specialized equipment for stages, tools, sports equipment, etc.

Radio-frequency identification (RFID) technology is known. This technology generally involves placing a unique tag on multiple assets such that a tag is associated with an asset. Multiple antennas are then placed throughout the storage site to cover all locations within the storage site. Each antenna may emit an electromagnetic pulse from a reader device to all tags within a known range of the antenna. Upon receiving an electromagnetic pulse, the tag broadcasts a radio signal that includes a unique identifier which is received by the reader device via the antenna. Since the location and the range of the antenna via which the response radio signal from the tag received, the general location within the storage site of the asset associated with the tag can be determined. By narrowing the location of the asset, the amount of time and resources used to retrieve an asset is reduced.

### BRIEF DESCRIPTION OF THE DRAWINGS

Reference will now be made, by way of example only, to the accompanying drawings in which:

FIG. 1 is a block diagram of an example apparatus to track assets fitted with radio-frequency identification tags by scanning multiple antennas;

FIG. 2 is a block diagram of another example apparatus to track assets fitted with radio-frequency identification tags by scanning multiple antennas;

FIG. 3 is a block diagram of an example system to track assets fitted with radio-frequency identification tags in a facility;

FIG. 4 is a block diagram of an another example system to track assets fitted with radio-frequency identification tags in a facility;

FIG. 5 is a representation of a storage facility deploying the system shown in FIG. 4 in an example configuration; and

FIG. 6 is a flowchart of an example method of tracking assets fitted with radio-frequency identification tags in a facility.

### DETAILED DESCRIPTION

Radio-frequency identification systems are known and may be used to track and manage assets in a storage site. In general, a radio-frequency identification system includes a radio-frequency identification reader, an antenna, and tags associated with an item to be tracked. In some examples, the radio-frequency identification reader may have the capability to support more than one antenna. Further multiplexing systems allow for each antenna output to be multiplexed to add additional antennas. For example, a four output radio-frequency identification reader may be used to support up to 32 antennas with multiplexing capabilities. In these examples, the radio-frequency identification reader generally manages the switching of the antenna via the multiplexer by sending control signals to the multiplexer, which in turn selects the required antenna input/output.

Assets used for commercial purposes to be owned by a party that is different from the one using the asset. There may be a number of reasons to manage assets in this manner. For example, there may be financial benefits, such as tax benefits. Furthermore, for certain types of assets where continuous use is not common or when the assets are used for a discrete period of times, such as for a specific project, the owner of the asset may achieve better utilization of the asset by providing the asset to multiple parties. Another example of a reason for renting or leasing an asset owned by another party may be due to the expertise of the party owning the asset to maintain the asset. For example, the skill set of a party using the asset may not include the skills for maintaining the assets in a good state of repair.

As an example, stage equipment used to form modern stages for performances, such as plays, concerts or lectures to provide sound and visual effects for the performance are often owned and managed by a party that is different from the performers. In most cases, the assets are not even owned by a venue as different stages may require different equipment to provide sound effects and/or visual effects. Sound effects may include generating background music, or amplifying sound from on the stage. Visual effects may include lighting and laser effects. Additional effects such as pyrotechnic displays and fog machines may be also used. Some of the equipment used to provide the sound and visual effects are to be positioned above the stage to improve the generated effect. For example, a light or laser source may be positioned above the stage so that light may be directed at the stage during a performance from above to achieve an appropriate lighting effect. Furthermore, such equipment may need to be supported around the stage with various trusses which may be provided by other parties. As another example, rental sporting equipment may be provided to athletes for use. In this example, a sporting venue such as a golf course, ski resort, or watersport rental shop may offer equipment for use by an athlete or participant. The equipment may include golf clubs, skis, watercrafts and associated personal protective equipment.

To protect the assets, the owners of the assets generally keep inventory to track each asset such that the location of the asset is known. In particular, the owner of the assets may want to know whether an asset in in the facility or at a specific location within the owner's facility. In some examples, assets may be scanned in and out of a facility to provide a record of whether the asset is expected to be inside the facility. However, once inside the facility, the asset may be moved to another location within the facility or may be removed from the facility without checking the asset out. In addition, assets may be returned to the facility without being properly checked in such that the status may indicate an asset is not in the facility when in fact the asset is inside the facility.

An apparatus and system to track assets fitted with a radio-frequency identification tags via multiple antennas is provided. While the apparatus may be combined with a radio-frequency identification reader that can resolve a location of the tags, the apparatus is generally intended to track static radio-frequency identification tags that are not moved frequently or quickly through the facility. However, if the cycle speed of the antennas is increased, the apparatus may be used as part of a system to track radio-frequency identification tags in real time as they move through a facility. The system uses radio frequency identification technology to track assets that are stored or placed near an antenna connected to a radio-frequency identification reader. Although radio frequency identification technology has been used to track assets in other examples, the present examples of the apparatus and system include an automatic switch that operates independently from the radio-frequency identification reader. In particular, the switch does not recognize any commands and operates autonomously. Accordingly, the switch may be a device that is more cost effective than a switch that is controlled externally, such as via commands from the radio-frequency identification reader.

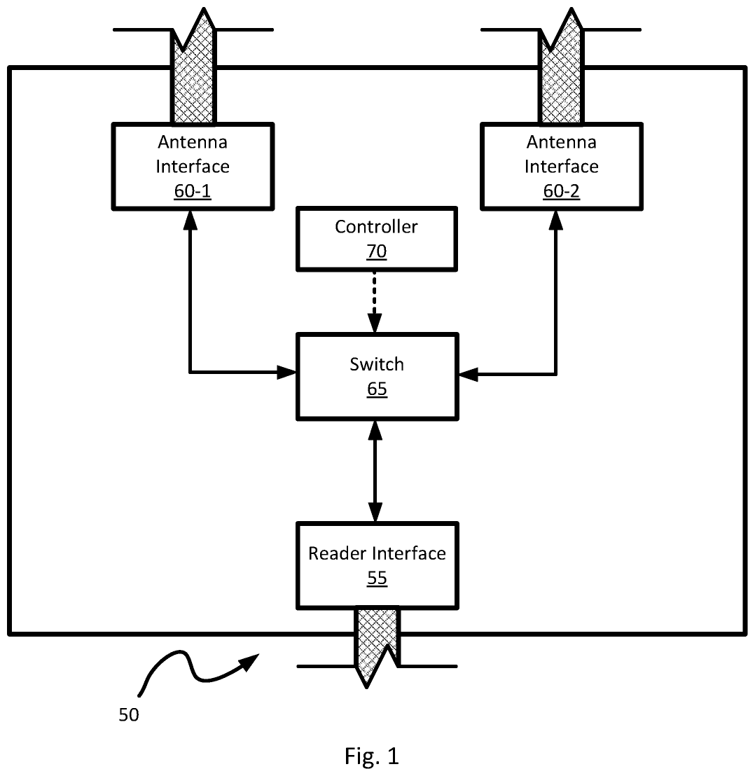

Referring to FIG. 1, an apparatus to track assets fitted with radio-frequency identification tags by scanning multiple antennas is generally shown at 50. The apparatus 50 may include additional components, such as additional interfaces or ports, status indicators, and/or manual input controls. In the present example, the apparatus 50 includes a reader interface 55, antenna interfaces 60-1 and 60-2 (generically, these antenna interfaces are referred to herein as “antenna interface 60” and collectively referred to as “antenna interfaces 60”), a switch 65, and a controller 70.

The reader interface 55 is provide a connection to a radio-frequency identification reader. The reader interface 55 is not particularly limited and may be any type of interface configured to receive a radio-frequency signal from the radio-frequency identification reader and to transmit a radio-frequency response signal to the radio-frequency identification reader. In the present example, the radio-frequency signals are carried via a coaxial cable. Accordingly, the reader interface 55 may be any type of coaxial cable connector, such as an RG-6 connector, a TNC connector, a RP-TNC connector, or a SMA connector.

The antenna interfaces 60 are to provide a connection to separate antennas. In the present example, each of the antennas connected to an antenna interface may be positioned within a facility at different locations. For example, the antenna connected to the antenna interface 60-1 may be placed to cover an adjacent area the area covered by the antenna connected to the antenna interface 60-2. The reader interface 55 is not particularly limited and may be any type of interface configured to receive a radio-frequency signal from the radio-frequency identification reader and to transmit a radio-frequency response signal to the radio-frequency identification reader. In the present example, the radio-frequency signals are carried via a coaxial cable. Accordingly, the reader interface 55 may be any type of coaxial cable connector, such as an RG-6 connector.

In Ir the present example, the switch 65 is to cycle between at least two different operating states. The manner by which the switch 65 cycles between the states is not particularly limited. For example, the switch 65 may be physical switch with a movable contact that can travel between multiple contact points when switching states. In other examples, the switch 65 may be an electronic switch without any moveable parts.

In a first state, the switch 65 connects the radio-frequency identification reader interface 55 to the antenna interface 60-1 in the present example. Accordingly, the radio-frequency signal may travel from the reader interface 55 to the antenna interface 60-1 to effectively connect an antenna associated with the antenna interface 60-1 to the radio-frequency identification reader. In this state, the radio-frequency identification reader can transmit a radio-frequency signal directly to the antenna. The signal is then broadcasted by the antenna and any radio-frequency tag within range of the antenna may respond with a response radio-frequency signal to be detected by the antenna. The response radio-frequency signal is carried back to the radio-frequency identification reader.

In a second state, the switch 65 connects the radio-frequency identification reader interface 55 to the antenna interface 60-2 in the present example. Accordingly, the radio-frequency signal may travel from the reader interface 55 to the antenna interface 60-2 to effectively connect a second antenna associated with the antenna interface 60-2 to the radio-frequency identification reader. In this state, the radio-frequency identification reader can transmit a radio-frequency signal directly to the second antenna. The signal is then broadcasted by the second antenna and any radio-frequency tag within range of the second antenna and may respond with a response radio-frequency signal to be detected by the antenna. The response radio-frequency signal is carried back to the radio-frequency identification reader. Accordingly, after the switch 65 has cycled through the two states, the radio-frequency identification reader is presented with two antennas to cover the space within the range of the antennas connected to the antenna interface 60-1 and the antenna interface 60-2.

The switch controller 70 is to operate the switch 65 automatically without receiving any external inputs or commands. In the present example, the switch controller 70 causes the switch to change between the two states described above. The manner by which the switch controller 70 operates is not particularly limited. For example, the switch controller 70 may cause the switch 65 change states after a fixed period of time referred to as a dwell time. The period of time is not limited and may be preset based on the characteristics of the system such as read time of the radio-frequency identification reader or the response time of the radio-frequency identification tags to be detected. The switch controller 70 may use a mechanical timer with internal moving components, such as gears, springs, and levers. In other examples, the switch controller may use an electrical or digital timer to determine when to change between the two states. The dwell time between changing states may be adjusted based on system requirements. For example, the switch controller 70a may include switches or other user interfaces to allow for a user to adjust the dwell time. In the present example, the dwell time may be adjustable from about 5 seconds to about 30 seconds to accommodate systems with varying amounts of expected tags. It is to be appreciated by a person of skill with the benefit of this description that the dwell time may be increased over 30 seconds for larger systems or systems with a higher expected density of tags. In other examples, the dwell time of the switch controller 70 may be fixed at a predetermined value during manufacturing such that an appropriate switch controller 70 is to be selected for an application.

It is to be appreciated by a person of skill with the benefit of this description that the switch controller 70 may be a self-contained unit that operates independently from any external inputs. In particular, the switch controller may operate independently from the operation of the radio-frequency identification reader such that the radio-frequency identification reader does not affect the operation of the switch controller 70. In some examples, the radio-frequency identification reader may treat the apparatus 50 as a single antenna that may cover a larger area using multiple antennas without using separate channels of the radio-frequency identification reader or additional radio-frequency identification readers.

By scanning multiple antennas covering a larger amount of space larger facilities, such as large warehouses with large racking systems, can be covered using existing equipment by retrofitting or adding the apparatus 50 into an existing radio-frequency identification system to perform continuous inventory verification. Reducing the number of radio-frequency identification readers used to detect radio-frequency identification tags provides additional benefits to the radio-frequency identification system. For example, adding more radio-frequency identification reader and antennas to increase coverage increases the amount of reader-reader interference. That is, the output from one radio-frequency identification reader may negatively impact the output from an adjacent antenna connected to another radio-frequency identification reader. An extended coverage model may also introduce increased costs due to the increased number of radio-frequency identification reader and associated multiplexers.

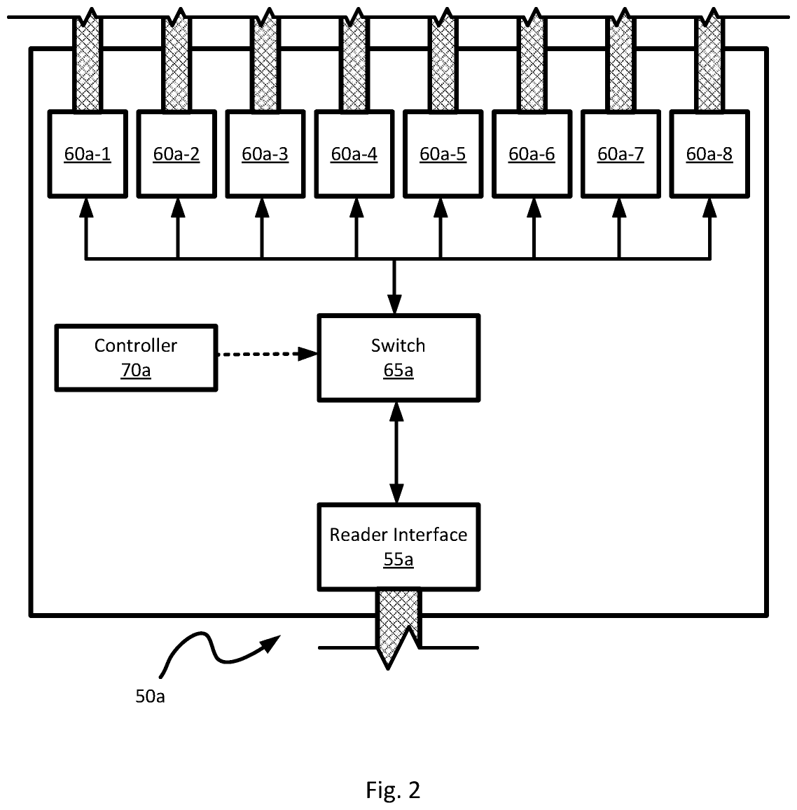

Referring to FIG. 2, another example of an apparatus 50a to track assets fitted with radio-frequency identification tags by scanning multiple antennas is generally shown. Like components of the apparatus 50a bear like reference to their counterparts in the apparatus 50, except followed by the suffix “a”. The apparatus 50a includes a reader interface 55a, antenna interfaces 60a-1, 60a-2, 60a-3, 60a-4, 60a-5, 60a-6, 60a-7, 60a-8 (generically, these antenna interfaces are referred to herein as “antenna interface 60a” and collectively referred to as “antenna interfaces 60a”), a switch 65a, and a controller 70a.

In the present example, the apparatus 50a is substantially similar to the apparatus 50. However, the apparatus 50a includes additional antenna interfaces 60a. It is to be appreciated by a person of skill with the benefit of this description that the additional antenna interfaces 60a allow for the connection of additional antennas to the radio-frequency identification reader via the reader interface 55a. By connecting more antennas to the reader interface 55a, a larger area may be covered by a channel of the radio-frequency identification reader connected to the reader interface 55a.

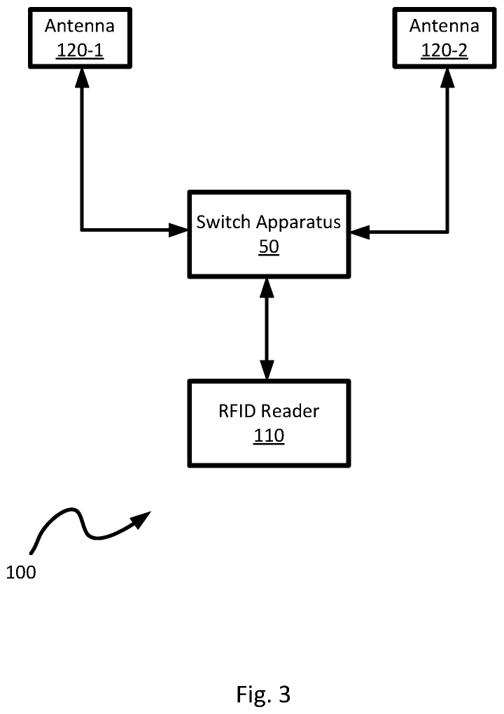

Referring to FIG. 3, a system 100 to track assets fitted with radio-frequency identification tags in a facility is generally shown. The system 100 may include additional components. In the present example, the system 100 includes an apparatus 50, a radio-frequency identification reader 110, and a plurality of antennas 120-1 and 120-2 (generically, these antennas are referred to herein as “antenna 120” and collectively referred to as “antennas 120”).

The radio-frequency identification reader 110 is not particularly limited. In the present example, the radio-frequency identification reader 110 is a device configured to read information from radio-frequency identification tags within range of an antenna 120. The radio-frequency identification reader 110 transmits radio-frequency signals via the antenna 120 in a process called interrogation that can be picked up by a radio-frequency identification tag within range of the antenna 120. The radio-frequency signals are not limited and may be in a wide range of bands. For example, the radio-frequency identification reader 110 may transmit signals in the range of about 2 meters to about 10 meters in some examples. In other examples, the signals transmitted by the radio-frequency identification reader 110 may have a frequency as low as about 30 KHz to reduce effects of metal and other materials through which the signal is to travel. Alternatively, the signals transmitted by the radio-frequency identification reader 110 may have a frequency as high as about 3000 MHz to have an extended range from the antenna 120 to reduce the number of antennas 120 for covering a fixed volume of space. In the present examples, frequencies in the range of about 860 MHz to about 930 MHz are used. It is also to be appreciated by a person of skill with the benefit of this description that the apparatus 50 may also be adapted to signals out of the radio-frequency ranges and operate in the microwave range, such as about 5.8 GHz.

The design and features of the radio-frequency identification reader 110 is not limited and may include various features. In the present example, the radio-frequency identification reader 110 includes a single input and output connector to communicate with an antenna 120. In particular, the radio-frequency identification reader 110 provide a signal to be transmitted by the antenna 120 and to receive a response signal from a radio-frequency identification tag within range of the antenna 120. Accordingly, it is to be appreciated by a person of skill with the benefit of this description that the antenna 120 may be connected directly to the radio-frequency identification reader 110 in examples where only a single antenna. In other examples, the radio-frequency identification reader 110 may include multiple channels for sending and receiving radio-frequency signals to different antennas 120 to provide multiplexing functionality using various control components to switch between the channels.

In operation, the radio-frequency signals transmitted by the antennas 120 are used to communicate with a radio-frequency identification tag. In particular, the signal provides power to the radio-frequency identification tag via inductive coupling to activate the electronics in the radio-frequency identification tag. The radio-frequency identification tag then generates a signal to be transmitted back to the radio-frequency identification reader 110. The signal generated by the radio-frequency identification tag includes data that identifies the tag, such as a serial number or other identifier, which is read and processed by the radio-frequency identification reader 110.

The antennas 120 are not particularly limited. In the present example, the antennas 120 are standalone antennas to be mounted at locations within a facility where assets are to be tracked. The antennas 120 may be connected to the apparatus 50 using a coaxial cable to carry the radio-frequency signal. By placing the antennas 120 proximate to each other, the volume of space, also referred to as a zone of coverage or interrogation zone, covered by the radio-frequency identification reader 110 may be increased by up to double the space a single antenna connected to the radio-frequency identification reader 110 can cover. In some examples, the antennas may be positioned such that the space covered by the antenna 120-1 may overlap with a portion of the space covered by the antenna 120-2 to avoid any spaces that are not covered and to provide a single continuous zone of coverage. In addition, multiple antennas 120 covering the same area may also provide more reliable results to locating a radio-frequency identification tag if the antennas 120 are all incident from different angles and locations as the environment may introduce objects that could interfere with the transmission of radio-frequency signals.

In the present example, the apparatus 50 is the apparatus described above and shown in FIG. 1. The apparatus 50 is to connect the radio-frequency identification reader 110 to both of the antennas 120 by cycling the connection between the antenna 120-1 and the antenna 120-2 to allow the radio-frequency identification reader 110 to send and receive radio-frequency signals from both antennas 120. It is to be appreciated by a person of skill with the benefit of this description that the radio-frequency identification reader 110 treats each antenna 120 the same do not interact with the apparatus 50. Since the operation of the radio-frequency identification reader 110 is not affected by the apparatus 50, the apparatus 50 may be used to retrofit existing systems by expanding the space covered by the radio-frequency identification reader 110 without upgrading the electronics of the radio-frequency identification reader 110 or modifying the antenna 120.

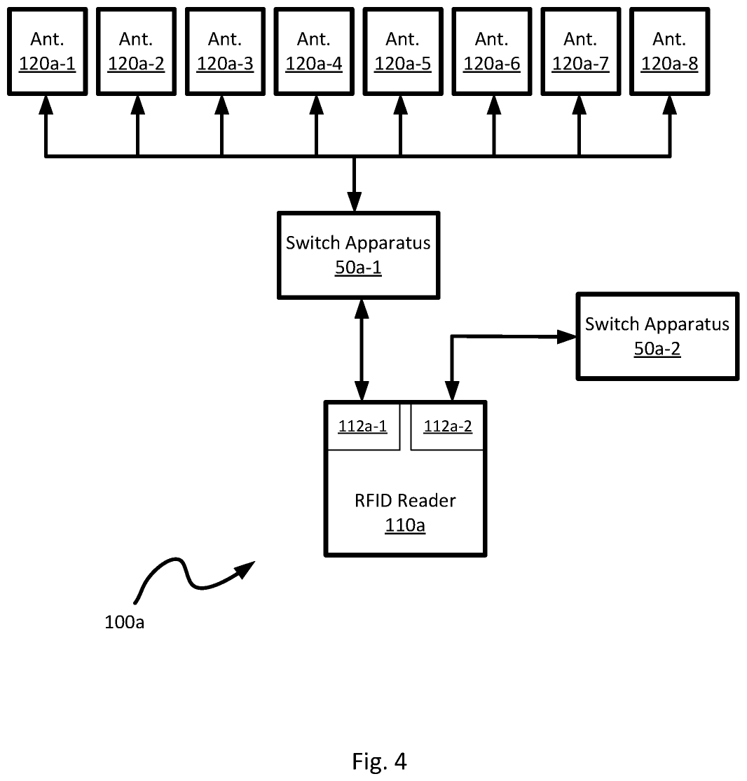

Referring to FIG. 4, another system 100a to track assets fitted with radio-frequency identification tags in a facility is generally shown. Like components of the system 100a bear like reference to their counterparts in the system 100, except followed by the suffix “a”. In the present example, the system 100a includes apparatuses 50a-1 and 50a-2 (generically, these apparatuses are referred to herein as “apparatus 50a” and collectively referred to as “apparatuses 50a”), a radio-frequency identification reader 110a, and a plurality of antennas 120a-1, 120a-2, 120a-3, 120a-4, 120a-5, 120a-6, 120a-7, and 120-8 (generically, these antennas are referred to herein as “antenna 120a” and collectively referred to as “antennas 120a”).

In the present example, the radio-frequency identification reader 110a transmits radio-frequency signals via an antenna 120a that can be picked up by a radio-frequency identification tag within range of the antenna 120a. The radio-frequency identification reader 110a further includes a channels 112a-1 and 112a-2 (generically, these channels are referred to herein as “channel 112a” and collectively referred to as “channels 112a”). Each of the channels 112a may be connected to a separate apparatus 50a such that an apparatus may be associated with a single channel 112a of the radio-frequency identification reader 110a. As a specific example shown in FIG. 4, the apparatus 50a-1 is associated with the channel 112a-1. The radio-frequency identification reader 110a may then cycle through the channels 112a either periodically or based on an algorithm to scan via both apparatuses 50a. For example, the algorithm may detect a period of no additional backscattered data form radio-frequency identification tags before switching channels. In the other examples, the radio-frequency identification reader 110a cycles through each channel with a predetermined scan time based on the system design, such as the anticipated number of radio-frequency identification tags in the coverage zone of an antenna 120. In some systems, the scan time may be about 0.25 s to about 1.0 s. However, in other examples, the radio-frequency identification reader 110a may be faster or slower. By associating the apparatus 50a with the channel 112a, the radio-frequency identification reader 110a may identify the channel 112a at which a radio-frequency identification tag responded to resolve the approximate location of the tag in the facility. Accordingly, if the antennas 120a associated with the apparatus 50a-1 are positioned proximate to each other, a radio-frequency identification tag may be approximately located within a facility to the zone covered by the plurality of antennas 120a associated with the apparatus 50a.

Although not shown, the apparatus 50a-2 may be substantially similar to the apparatus 50a-1 and have a plurality of proximate antennas connected thereto. For example, the apparatus 50a-2 may have eight antennas connected thereto to provide a total of sixteen antennas to scan for radio-frequency identification tags using two channels 112a. In further examples, the radio-frequency identification reader 110a may have additional channels 112a to connect with additional apparatuses 50a and thus scan more antennas 120a. Furthermore, it is to be appreciated by a person of skill with the benefit of this description that additional channels 112a provide better resolution of the location of a tag detected by the radio-frequency identification reader 110a.

The manner by which each apparatus 50a cycles through the antennas 120a and the radio-frequency identification reader 110a cycles through the channels 112a is not particularly limited. Since the apparatus 50a and the radio-frequency identification reader 110a do not communicate with each other, their operational states are unknown. Accordingly, the relative cycle frequencies are to be set to avoid missing a scan from an antenna 120a which would leave a zone that did not complete an inventory round. As there is no communication between each apparatus 50a and the radio-frequency identification reader 110a, the radio-frequency identification reader 110a treats all antenna 120a as indistinguishable. To reduce the likelihood of missing an antenna, the cycle frequency of the apparatus 50a between each antenna 120a may be set to be slower than the cycle frequency of the radio-frequency identification reader 110a. In other words, the dwell time of the apparatus 50a may be longer than the scan time for each channel of the radio-frequency identification reader 110a. Accordingly, the radio-frequency identification reader 110a may be allowed to cycle through one or more channels 112a before the apparatus 50a switches to the next antenna 120a. In other examples, the cycle frequency of the apparatus 50a between each antenna 120a may be set to be much faster than the cycle frequency of the radio-frequency identification reader 110a. In this example, the radio-frequency identification reader 110a would scan all antennas 120a associated with a specific channel 112a before switching to another channel 112a.

In the present example, the radio-frequency identification reader 110a complies with the EPC Gen2v2/ISO 18000-6 standard. Accordingly, the radio-frequency identification reader 110a carries out an interrogation process to identify any radio-frequency identification tags by transmitting radio-frequency signals and monitoring for responses. In an inventory round, the radio-frequency identification reader 110a detects and processes responses from radio-frequency identification tags one at a time to cycle through the radio-frequency identification tags within range of the antennas 120a has responded until the inventory round ends and the radio-frequency identification reader 110a moves on to another channel 112a. The manner by which the inventory round ends is not particularly limited and may involve various reasons, such as an arbitrary timeout after a predetermined period of time, a predetermined max count of radio-frequency identification tags, failure to detect additional radio-frequency identification tags with a predetermined minimum received signal strength indicator (RSSI) value, or an anti-collision algorithm has been saturated. The rate at which the radio-frequency identification reader 110a and thus the time used to complete an inventory round is not particularly limited and is subject to a theoretical upper limit if the radio-frequency identification reader 110a complies with the standard. The actual upper limit may vary based on various factors such as the radio-frequency identification reader 110a hardware capabilities, the radio-frequency identification tag population density, and the communication protocol used. Assuming an environment with no interference, noise or tag collisions, the theoretical upper limit of inventory rounds that a compliant RFID interrogator can make per second can be calculated with the following equation:

$$Maximum inventory rounds per second = \frac{Reader ’ s cycle time}{{T}_{a r i} + {T}_{a r i} / 4 + {T}_{fixed} + ( {T}_{s l o t} \times Q )}$$

where
Tₐᵣᵢ is the length of the reader's minimum pulse interval;
T_{fixed} is the fixed time interval for the reader to switch between transmitting and receiving modes;
Tₛₗₒₜ is the time interval to listen for a response (referred to as a slot)
Q is the number of slots in a round

For example, assuming the radio-frequency identification reader 110a has a cycle time of 1 ms, Tₐᵣᵢ of 6.25 μs, T_{fixed} of 20 μs, Tₛₗₒₜ of 8.25 μs, and Q of 16 slots, the upper limit on the inventory rounds per second can be calculated to be 57.14 inventory rounds per second which means that the radio-frequency identification reader 110a may read up to 57 radio-frequency identification tags every second. During each inventory round, many tags may be read and the radio-frequency identification reader 110a carries out a process to avoid reading the same radio-frequency identification tag in an inventory round using an anti-collision algorithm. The anti-collision algorithm is not particularly limited and in the present example. In the present example, a query tree protocol is used.

Accordingly, the frequency at which the apparatus 50a switches the antenna 120a may vary depending on the number of anticipated radio-frequency identification tags within range of each antenna 120a. For example, if about a hundred radio-frequency identification tags are expected within a zone covered by the switching apparatus 50a, switching the antennas 120a at an interval or dwell time of several seconds can provide sufficient inventory rounds (including repeated rounds with alternate configurations and accounting for frequency hopping) will have been completed to capture substantially all of the radio-frequency identification tags in the zone.

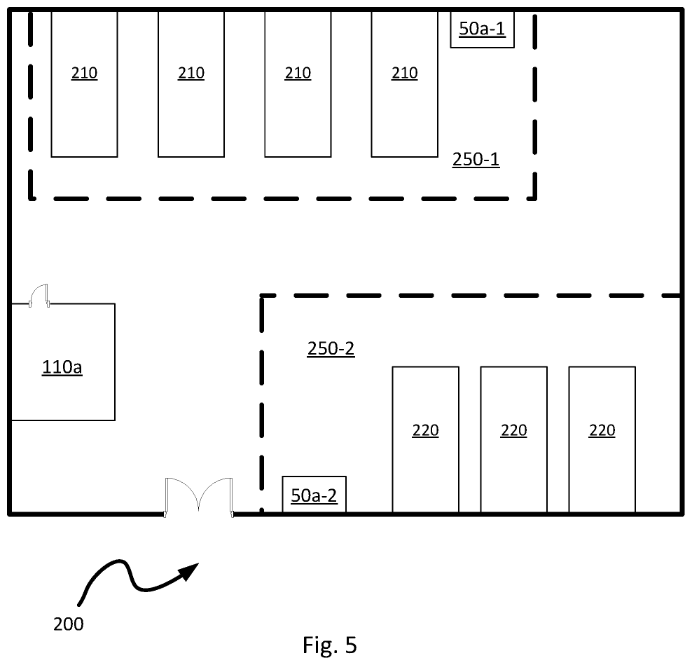

Referring to FIG. 5, an example of the system 100a deployed in a storage facility 200 is generally shown. In the present example, the storage facility 200 includes a plurality of storage units 210 and 220 disposed across rooms 250-1 and 250-2, respectively, and a radio-frequency identification reader 110a. The storage units 210 and 220 are to store assets and not particularly limited. Depending on the type of asset to be stored in the storage units 210 and 220, the storage unit may include racks, hangers, cabinets, etc. Each storage unit 210 and 220 is to have at least one antenna 120 mounted thereon. In examples where each storage unit 210 and 220 is sufficiently tall, additional antennas 120 may be mounted at different heights to provide a zone of coverage that covers substantially the entire rack.

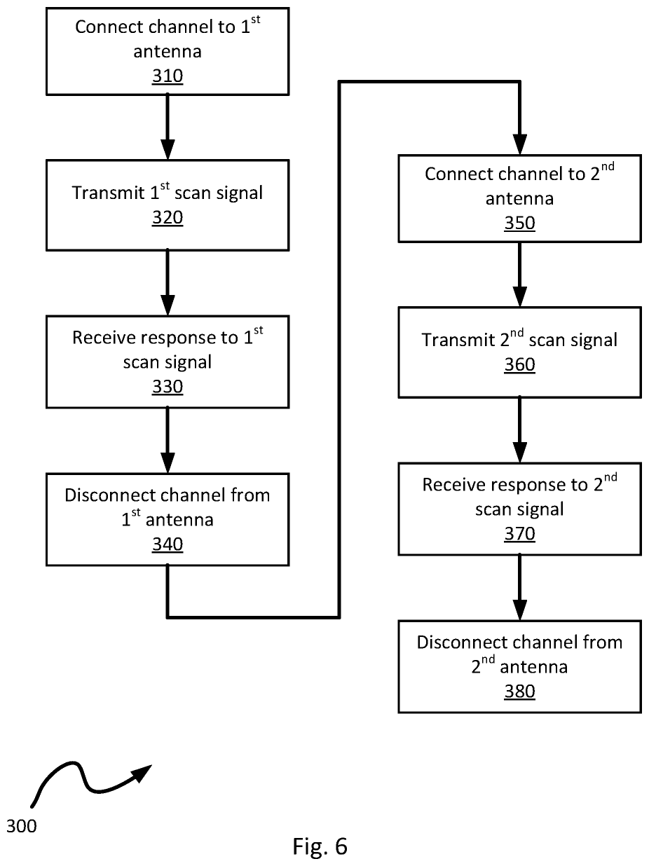

Referring to FIG. 6, a flowchart of a method 300 of tracking assets fitted with radio-frequency identification tags in a facility is generally shown. In order to assist in the explanation of method 300, it will be assumed that method 300 may be performed with the system 100a. Indeed, the method 300 may be one way in which system 100a may be configured. Furthermore, the following discussion of method 300 may lead to a further understanding of the system 100a and its various components.

Block 310 involves connecting a channel 112a-1 from the radio-frequency identification reader 110a to an antenna 120a-1 with the switching apparatus 50a-1. The manner by which the connection is made is not particularly limited and may involve connecting cables capable of carrying a radio-frequency signal with a switch 65a. In the present example, the radio-frequency signals are carried via a coaxial cable and the connection may be made using a coaxial switch box.

Next, block 320 comprises transmitting a scan signal from the radio-frequency identification reader 110a connected to the antenna 120a-1 via the switching apparatus 50a-1. The scan signal provides power to a radio-frequency identification tag within range of the antenna 120a-1 via inductive coupling. Upon activation of the radio-frequency identification tag, the radio-frequency identification tag generates a response signal to be transmitted back to the radio-frequency identification reader 110a from the radio-frequency identification tag received via the antenna 120a-1 and the switching apparatus 50a-1 at block 330. Block 320 and block 330 may then be repeated multiple times during an inventory round to scan for multiple radio-frequency identification tags within the zone covered by the antenna 120a-1.

After the inventory round is completed, the channel 112a-1 of the radio-frequency identification reader 110a is disconnected from the antenna 120a-1 at block 340. The switching apparatus 50a-1 then connects the channel 112a-1 of the radio-frequency identification reader 110a to the antenna 120a-2 at block 350. It is to be appreciated by a person of skill with the benefit of this description that in other examples, the switching apparatus 50a-1 may connect the channel 112a-1 to any other antenna 120a and that this process may be iterated until all antennas 120a are connected to the channel 112a-1 for an inventory round.

Once the antenna 120a-2 is connected to the channel 112a-1, a scan signal is transmitted from the radio-frequency identification reader 110a connected to the antenna 120a-2 via the switching apparatus 50a-1 at block 360. The scan signal provides power to a radio-frequency identification tag within range of the antenna 120a-2 via inductive coupling. Upon activation of the radio-frequency identification tag, the radio-frequency identification tag generates a response signal to be transmitted back to the radio-frequency identification reader 110a from the radio-frequency identification tag received via the antenna 120a-2 and the switching apparatus 50a-1 at block 370. Block 360 and block 370 may then be repeated multiple times during an inventory round to scan for multiple radio-frequency identification tags within the zone covered by the antenna 120a-2. After the inventory round is completed, the channel 112a-1 of the radio-frequency identification reader 110a is disconnected from the antenna 120a-2 at block 380. The process may then be iterated with the remaining antennas 120a while the radio-frequency identification reader 110a continues to scan the channel 112a-1. Upon cycling through all the antennas 120a, the radio-frequency identification reader 110a may switch to channel 112a-2 to repeat the process with the switching apparatus 50a-2.

Various advantages will now be apparent to a person of skill in the art with the benefit of the present description. In particular, the apparatuses 50 and 50a provide a way increase a zone of coverage for a radio-frequency identification reader without the addition of additional channels or multiplexer controlled by the radio-frequency identification reader. In particular, by using an automatic switch that is preset at installation, the apparatuses 50 and 50a may be installed in an existing radio-frequency identification system to increase the number of antennas without additional components or modification to the radio-frequency identification reader.

It should be recognized that features and aspects of the various examples provided above may be combined into further examples that also fall within the scope of the present disclosure.

What is claimed is:

1. An apparatus comprising:
a reader interface to connect to a radio-frequency identification reader;
a first antenna interface to connect to a first antenna;
a second antenna interface to connect to a second antenna;
a switch to connect the first antenna interface to the reader interface in a first state and to connect the second antenna interface to the reader interface in a second state, wherein the radio-frequency identification reader is to transmit a signal via the first antenna and to receive a first response from a tag via the first antenna in the first state, and wherein the radio-frequency identification reader is to transmit the signal via the second antenna and to receive a second response from a tag via the second antenna in the second state; and
a switch controller to operate the switch automatically.

2. The apparatus of claim 1, wherein the reader interface is to connect to a single channel of the radio-frequency identification reader.

3. The apparatus of claim 1, wherein the switch controller causes the switch to change between the first state and the second state.

4. The apparatus of claim 3, wherein the switch controller changes between the first state and the second state after a fixed period of time.

5. The apparatus of claim 4, wherein the switch controller is mechanical.

6. The apparatus of claim 4, wherein the switch controller is electrical.

7. The apparatus of claim 4, wherein the switch controller changes the switch between the first state and the second state at a slower frequency than a scan cycle of the radio-frequency identification reader.

8. The apparatus of claim 1, wherein the switch operates independently from the radio-frequency identification reader.

9. A system comprising
a radio-frequency identification reader with a plurality of channels, wherein each channel of the plurality of channels is to transmit a scan signal and to receive a response signal;
a plurality of proximate antennas to communicate with a radio-frequency identification tag, wherein the radio-frequency identification tag is to generate the response signal; and
a switching apparatus to connect a channel of the plurality of channels to the plurality of proximate antennas, wherein the switching apparatus cycles through the plurality of proximate antennas to allow the channel to transmit the scan signal via each antenna of the plurality of proximate antennas.

10. The system of claim 9, wherein the switching apparatus includes a switch controller to select an antenna of the plurality of proximate antennas to connect to the channel for a period of time.

11. The system of claim 10, wherein the switch controller includes a mechanical timer to measure the period of time.

12. The system of claim 10, wherein the switch controller includes an electrical timer to measure the period of time.

13. The system of claim 10, wherein the period of time is longer than a scan time for the channel by the radio-frequency identification reader.

14. The system of claim 9, wherein the switching apparatus operates independently from the radio-frequency identification reader.

15. The system of claim 9, wherein the plurality of proximate antennas covers a zone assigned to the switching apparatus.

16. A method comprising:
connecting a channel from a plurality of channels from a radio-frequency identification reader to a first antenna with an automatic switch;
transmitting a first scan signal from the radio-frequency identification reader via the first antenna;
receiving a first response signal from a radio-frequency identification tag via the first antenna;
disconnecting the channel from the first antenna with the automatic switch;
connecting the channel to a second antenna with the automatic switch;
transmitting a second scan signal from the radio-frequency identification reader via the second antenna;
receiving a second response signal from a radio-frequency identification tag via the second antenna; and
disconnecting the channel from the second antenna with the automatic switch.

17. The method of claim 16, further comprising timing a connection between the channel to the first antenna with the automatic switch.

18. The method of claim 16, wherein a connection time between the channel and the first antenna is longer than a scan time for the channel by the radio-frequency identification reader.

19. The method of claim 16, wherein connecting the channel to the first antenna is carried out independently from operation of the radio-frequency identification reader.

20. The method of claim 16, further comprising covering a continuous zone assigned to the switch with the first antenna and the second antenna.
